(19) United States
(12) Patent Application Publication
(10) Pub. No.: US 2002/0124667 A1
(43) Pub. Date: Sep. 12, 2002

(54) Centrifugal force converter

(76) Inventor: Lawrence D. Murray, Kingsland, GA (US)

Correspondence Address: HINKLE & O'BRADOVICH, LLC, 395 SCENIC HIGHWAY, LAWERENCEVILLE, GA, 30045, US

(21) Appl. No.: 10/068,993

(22) Filed: Feb. 7, 2002

Related U.S. Application Data
(60) Provisional application No. 60/267,339, filed on Feb. 8, 2001.

(51) Int. Cl. F16H 33/00

(52) U.S. Cl. 74/84 S

(57) ABSTRACT

A mechanical force generator for producing a unidirectional force by converting rotational force energy to a directional force by rotating a plurality of force generating units within a housing. Each force generating unit has a plurality of eccentrics mounted within an elongated structure. The eccentrics rotate around a shaft mounted transversely to the centerline of the elongated structure, and the structure rotates around its centerline, powered by a rotational force supplied to the housing. The rotation of the eccentrics produce a resultant unidirectional force.

This application is a utility application which claims the benefit of priority of U.S. Provisional Patent Application No. 60/267,339, filed on Feb. 8, 2001, entitled “Centrifugal Force Converter”.

### BACKGROUND OF THE INVENTION

I. Field of the Invention

The present invention relates generally to an apparatus for producing a directional force and, more particularly, to an apparatus for converting centrifugal energy to a directional force by rotating a plurality of shafts which then turn right angle beveled gears to rotate individual power units about their respective longitudinal center lines to cause rotation of transversely mounted shafts having sets of eccentrics mounted thereon to produce a net unidirectional force in a direction as determined by the user.

II. Description of the Related Art

Various devices are well known in the prior art which transmit energy and converts that energy from linear to rotational and vice versa. Many such devices use eccentrics to modify the resultant force output.

For instance, the patent to Mount (U.S. Pat. No. 4,072,066) discloses a transmission which uses eccentrics to control power output by having the eccentrics mounted transversely to the drive axis to modify the drive ratio of a planetary gear transmission by centrifugal force associated with a rotor assembly having an imbalance that varies as a function of the speed of oppositely rotating eccentric rotor elements relative to a carrier frame mounting planetary gears drivingly connected to a spider on which the rotor assembly is mounted.

In the Peterson Patent (U.S. Pat. No. 4,744,259) there is disclosed a device for generating a unidirectional force comprising a rotary body carrying around its periphery a plurality of pivotal pendulum masses mounted on shafts parallel to the axis of rotation of the rotary body so that the pendulum masses swing transversely to the main access of rotation. As the device rotates, each pendulum mass flings outwardly to produce a unidirectional force symmetrical about a central axis.

The Moller Patent (U.S. Pat. No. 4,307,629) discloses a torque converter having an input shaft, an output shaft and preferably three or more torque generating trains each having a rotatable shaft whose axes are fixed relative to the axis of an input shaft. Each of the torque generating trains has a pair of doubleweight torque generators thereon wherein the weights are eccentrically mounted upon the shaft of their respective torque generating trains. However, in each torque generator a pair of substantially identical weights are mounted for freedom of rotation relative to a pair of cylindrical bearing surfaces which are eccentrically positioned relative to the axis of their torque generating train shafts and which have their eccentricities 180° apart on the shafts. As the cage of the device is spun about the axis of its torque generating train, the eccentrically mounted weights are also spun with the cage and the weights apply torque to the shafts of their torque generating trains.

### SUMMARY OF THE INVENTION

In accordance with the present invention and the contemplated problems which have and continue to exist in this field, the present invention will produce a unitary unidirectional force which may be directed angularly, transversely from a central axis of rotation of the device as needed.

The invention accomplishes the above and other objects of the invention by utilizing rotating masses to achieve a unidirectional force. A timing system is included in order to achieve the directional force output. The invention comprises a housing having a power input mechanism at one end to rotate longitudinal shafts which connect to individual power output units comprising rotating eccentrics to develop a net unidirectional output force.

In the input power gear train, the center gear accepts outside power, transmits it to turn planetary gears which then turn input drive shafts and right angle gears. This rotates the entire individual power units around stationery sun bevel gears. By rotating the individual power units, planetary gears walk around a stationery bevel sun gear causing the planetary gears to activate and rotate the eccentrics, thus activating a force on the main support shafts. The stationery sun bevel gears remain stationery until moved to affect the timing. By changing the timing, the eccentrics are repositioned and this changes the focal points in the longitudinal plane of 360°. To change to focal points in a latitudinal plane of 360°, the entire unit must be rotated to whatever degree is desired.

To achieve the above results, the entire assembly must be mounted in a vertical position. If the housing assembly is mounted horizontally then the longitudinal and latitudinal planes are reversed. By using two modes of timing, the resultant output force can be focused on any point of a sphere. The focal points can be reversed by 180° within five seconds or less without power reduction or rpm's being sacrificed.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 is a side elevation view, partially in section, showing an individual power unit;

FIG. 2 is an end elevation view of FIG. 1, partially in section;

FIG. 3 is an end view of FIG. 1;

FIG. 4 is a perspective view of the individual power unit of FIG. 1;

FIG. 5 is a sectional end view of FIG. 4;

FIG. 6 is an end view of FIG. 4;

FIG. 7 is an elevation view of the individual power unit rotated an additional 45°;

FIG. 8 is a sectional end view of FIG. 7;

FIG. 9 is an end view of FIG. 7;

FIG. 10 is an elevation view of the individual power unit rotated an additional 45°;

FIG. 11 is a sectional end view of FIG. 10;

FIG. 12 is an end view of FIG. 10;

FIG. 13 is an elevation view of the individual power unit rotated an additional 45°;

FIG. 14 is a sectional end view of FIG. 13;

FIG. 15 is an end view of FIG. 13;

FIG. 16 is an elevation view of the individual power unit rotated an additional 45°;

FIG. 17 is a sectional end view of FIG. 16;

FIG. 18 is an end view of FIG. 16;

FIG. 19 is an elevation view of the individual power unit rotated an additional 45°;

FIG. 20 is a sectional end view of FIG. 19:

FIG. 21 is an end view of FIG. 19;

FIG. 22 is an elevation view of the individual power unit rotated an additional 45°;

FIG. 23 is a sectional end view of FIG. 22;

FIG. 24 is an end view of FIG. 22;

FIG. 25 is an exploded perspective view of one individual power unit;

FIG. 26 illustrates the drive train input power gears with the drive shaft and right angle drive gears showing the rack gears meshing with the timing gears, which are mated to the sun bevel gear to affect the timing through 360° of longitudinal rotation; and

FIG. 27 shows three eccentric assembly units, one of which has been shown in cross-section to show inner parts of the assembly and further showing the mounting plates along with the outer plates, both top and bottom, and end mounting plates.

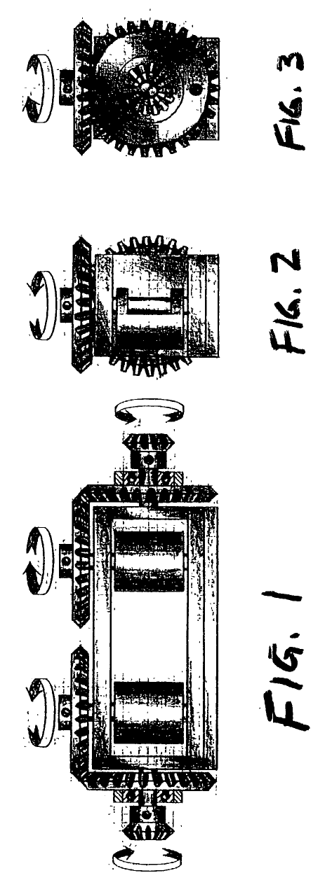

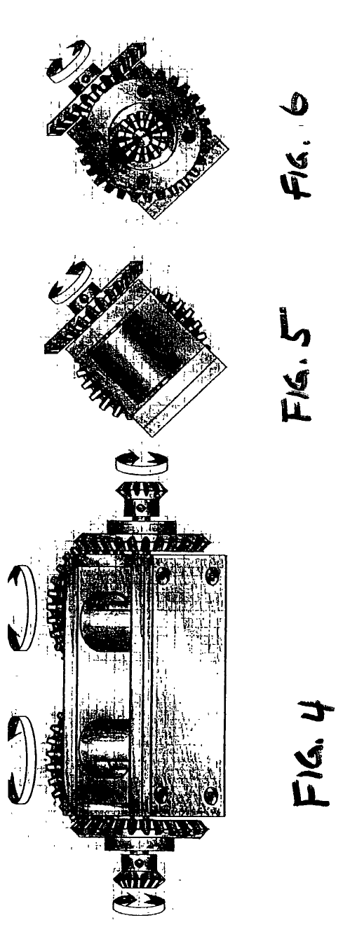

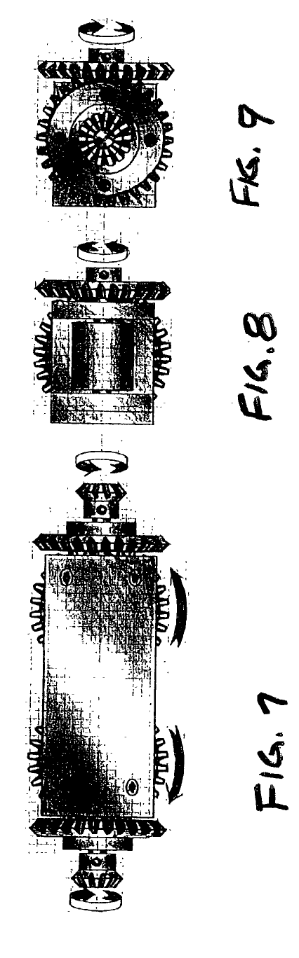

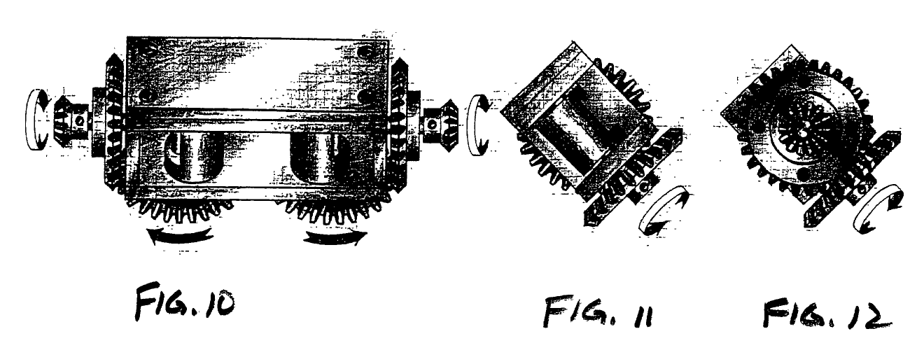

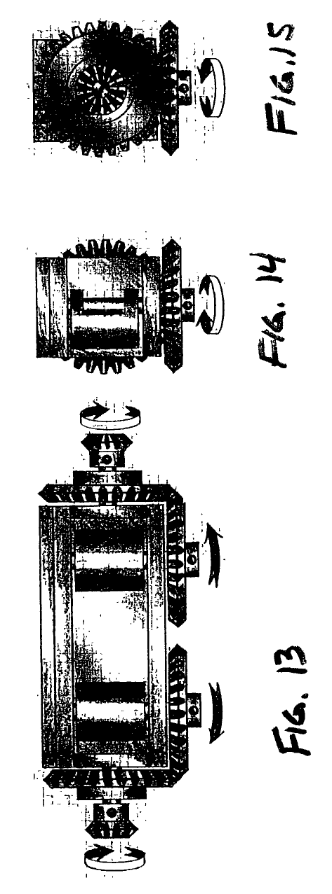

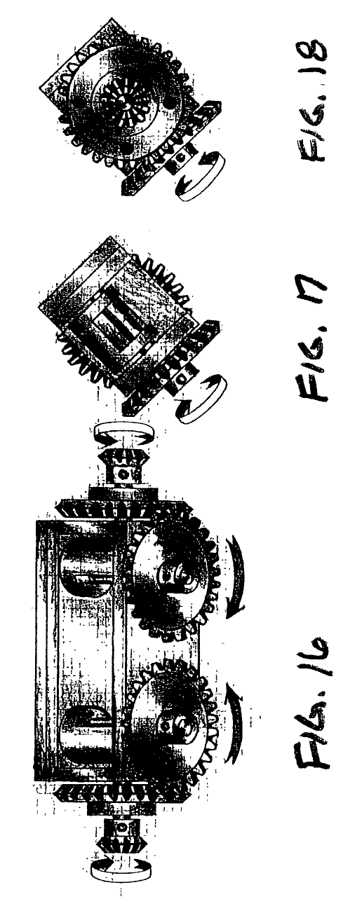

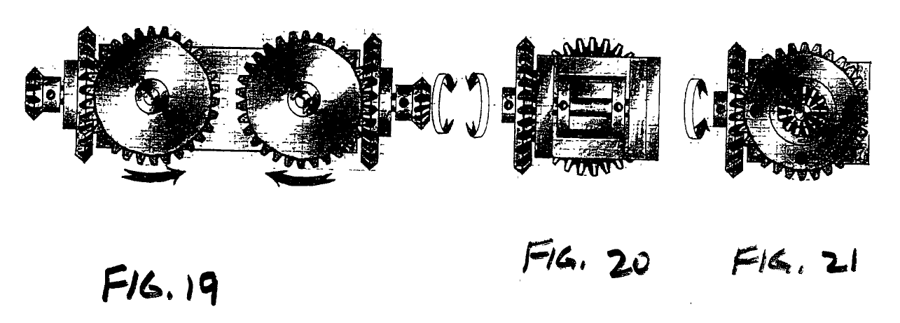

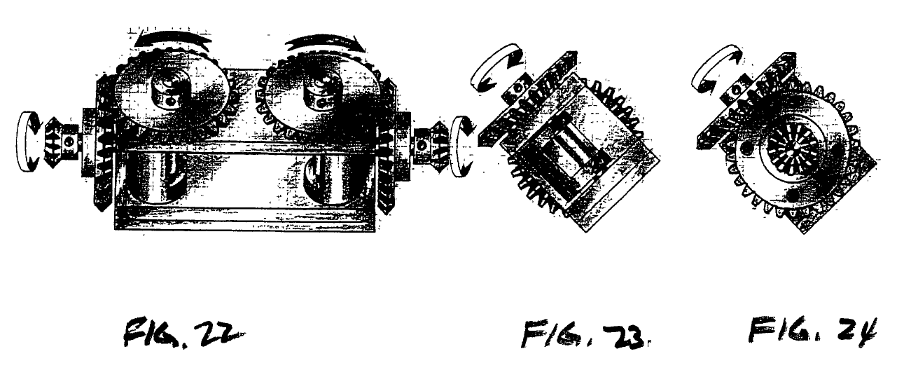

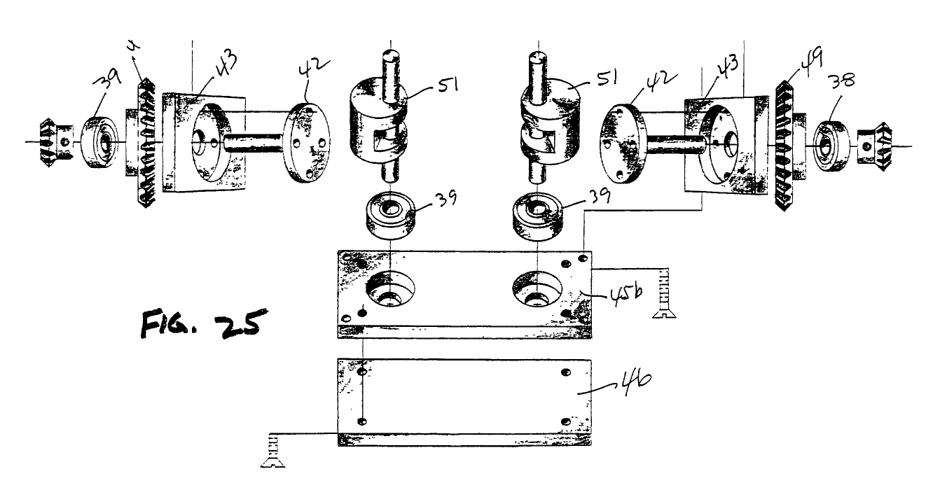

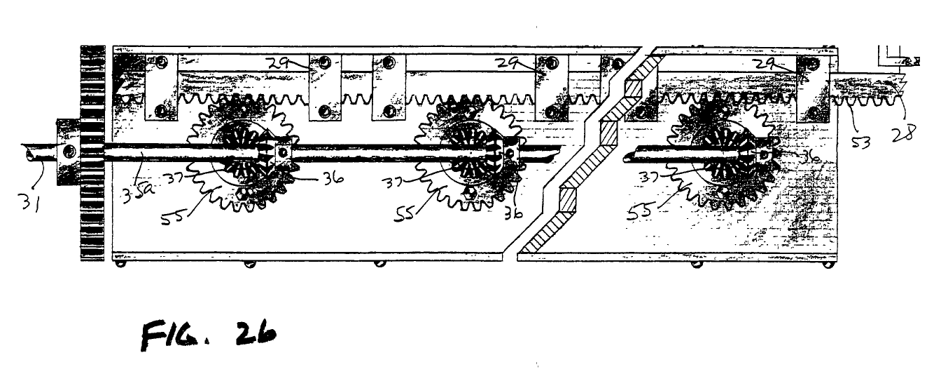

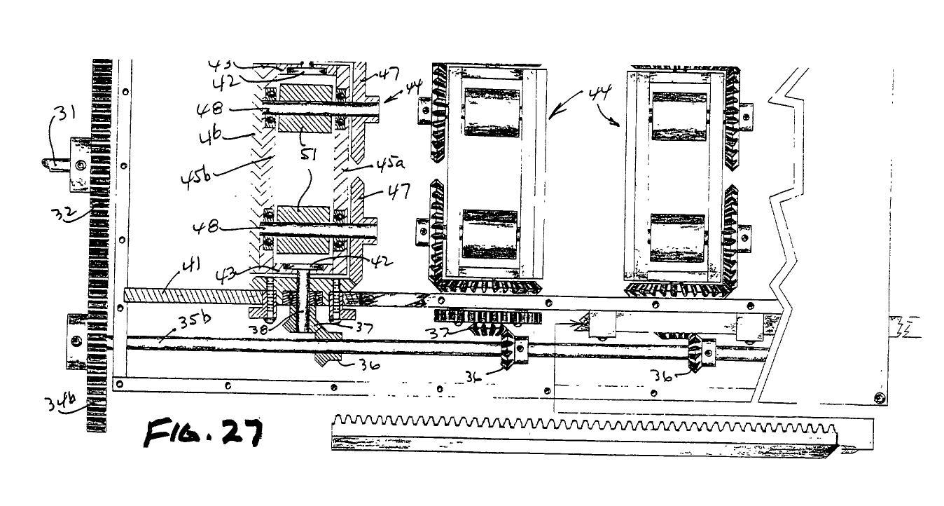

### DETAILED DESCRIPTION OF THE INVENTION

Referring to the drawings wherein like reference numerals designate corresponding parts throughout the several figures, reference is made first to FIGS. 9, 10 and 11. The centrifugal force converter of the present invention is generally indicated by numeral 21. The converter 21 generally comprises a housing 22 having a frame 23 which encloses the operative parts of the invention. On the exterior of the frame 23, a linear actuator 24 is mounted by suitable mounting bracket 25 and has extending from one end thereof of an actuating rod 26. The linear actuator is shown in diagramatic fashion inasmuch as the actuator may take any number of forms such as being hydraulic or electrical in nature, or being any other type of actuator which would accomplish the intended purposes. The purpose of the linear actuator is to move the actuating rod 26 in and out of the mounting bracket 25 to ultimately move the mounting plate 27, which is affixed to the rack gear 28. The rack gear generally is juxtaposed to a frame 23 and held in position by several rack guides 29. In the present embodiment it can be seen that the rack gear 28 is mounted exteriorly of the frame 23, however, it is within the purview of this invention that the linear actuator and rack gear all could be mounted within the frame 23 with other components of the invention, if such should be desired.

Input shaft 31 is supplied with rotational power from a suitable source (not shown) to rotate the input sun gear 32, which is fixedly mounted on shaft 31 and lies closely adjacent end plate 33 of frame 23. When the input sun gear 32 rotates, it causes power input planet gears 34a and 34b to rotate in the same direction and to turn the input drive shafts 35a and 35b located within frame 23.

Referring now especially to FIG. 11 showing an elevation view partially in section of the centrifugal force converter 21, it is seen that the input drive shafts 35a and 35b have mounted therein a plurality of shaft bevel gears 36 which mesh with planetary beveled gears 37 which are affixed to main assembly drive shafts 38. The main assembly drive shafts 38 project through the shaft bearings 39 which are mounted in the support plates 41 and terminate in the main assembly drive disk 42. The main assembly drive disk 42 are fixedly mounted to the end support plates 43 which comprise the ends of each individual power unit 44.

Each individual power unit 44 has, in addition to end plates 43, side plates 45a and 45b. Adjacent side plates 45b there is mounted a counterweight 46 to counterbalance the weight of side mounted planetary gears 47. Each side planetary gear 47 is mounted to a respective eccentric shaft 48 and also engages the stationary sun bevel gear 49, which is fixedly mounted to its respective support plate 41.

Referring again, especially to FIG. 11, it is seen that when side planetary gears 47 are cause to rotate around stationary sun gear 49 due to the action of the main assembly drive shaft 38, the rotation of the side planetary gears 47 will cause eccentric shaft 48 to turn carrying with it the eccentrics 51 causing the eccentrics to move the off-center mass centers thereof to translate the rotational force to a centrifugal force. As seen in FIG. 9, the eccentrics 51 have a cutout portion 52 in the area of the eccentric shaft 48 to move the mass centers of the eccentrics more to one edge than the other.

Again, returning to FIGS. 10 and 11, it can be seen that when the actuating rod 26 is reciprocated by the linear actuator 24, the rack gear 28 is caused to reciprocate wherein the teeth 53 of the rack gear engage the teeth 54 of the timing gear 55, which timing gear is fixed to the stationary sun gear 49 thereby causing the sun gear to rotate and effectively carrying with it the respective individual power units 44 in an angular direction. Obviously, all of the individual power units would be carried in an angular direction of the same magnitude, because all are connected to the rack gear. It should be noted that the rack gear 28, instead of being a linear member as shown in this embodiment, could have substituted therefor individual gear drives to move each individual power unit individually.

It is anticipated in operation of the unit that when a unit is constructed, the unit may include many multiples of individual power units depending on the amount of resultant force required. The present embodiment only shows three individual power units in one housing and, for the purposes herein, three individual power units illustrate the invention. For instance, to vary the force output, each of the three individual power units 44 shown could be angularly displaced one from the other a desired number of angular degrees to produce a force output consistent with a desired amount. Once the individual power units are angularly disposed, they do not change angular position relative to one another even when the rack gear is moved causing the timing gear to change the angular disposition of the units. In the present invention, there are two timing units of changing the resultant force output. The first is as just described utilizing the rack gear 28. The second method would be to turn the housing 22 by means of a power unit (not shown) at the end of the housing, wherein the entire housing would be turned an angular direction as desired.

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A force generator comprising:
a housing having a proximal end and a distal end, a power unit sun gear juxtaposed to the proximal end, the housing having a longitudinal centerline, at least two planet gears engaging the power input sun gear, each planet gear fixedly mounted to an input drive shaft rotatively mounted in the proximal end of the housing and projecting to the housing parallel to the centerline of the housing,
a plurality of shaft gears mounted to the input drive shafts, multiple opposed support plates being fixed within the housing and being parallel to the centerline of the housing,
a plurality of individual power units mounted between the opposed support plates, each power unit having a shaft projecting from each opposed support plate along a plane defining the longitudinal centerline of the respective power unit, the individual power units being coupled to individual shaft gears along the longitudinal centerline of each power unit,
each individual power unit having an elongated body having opposed ends fixed to the power unit shafts to cause rotation of the power unit about the longitudinal centerline of the power unit,
a plurality of eccentrics mounted on respective shafts within the elongated body of each individual power unit and geared to a respective opposed end shaft for rotation of the eccentric within the power unit, and
timing means mounted to the housing and coupled to each individual power unit.

2. A force generator as claimed in claim 1, wherein the shafts mounting the eccentrics in the individual paver units are mounted transversely to the longitudinal centerline of the respective power unit.

3. A force generator as claimed in claim 1, wherein the timing means comprises an actuator juxtaposed to the housing, an actuator member coupling the actuator to an elongated rack gear, the rack gear coupled to at least one power unit shaft in each power unit.

4. A force generator as claimed in claim 3, wherein the actuator member is coupled to two elongated rack gears, each rack gear being coupled to respective power unit shafts in each power unit.

5. A force generator as claimed in claim 1, wherein the timing means comprises an actuator juxtaposed to the housing, an actuator member coupling the actuator to the housing causing the housing to rotate in predetermined angular increments.
